(19) United States
(12) Patent Application Publication
(10) Pub. No.: US 2004/0205732 A1
(43) Pub. Date: Oct. 14, 2004

(54) Cross-platform porting tool for web applications

(76) Inventor: Paul Parkinson, Mt. Royal, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/411,833

(22) Filed: Apr. 11, 2003

(51) Int. Cl. G06F 9/45; G06F 15/00

(52) U.S. Cl. 717/137; 717/136; 715/513

(57) ABSTRACT

A software tool is disclosed comprising conversion logic for automatically porting a web application from a first application server format to a second application server format, and a user interface for receiving user input, wherein the conversion logic automatically executes according to the user input.

### FIELD OF THE INVENTION

The present invention relates, in general, to software applications, and, more specifically, to a tool for porting web applications among application server platforms.

### DESCRIPTION OF RELATED ART

The Internet has expanded at an incredible pace since originating as a means for scientists to communicate and easily exchange information. Faster communication speeds and greater access to computers increased the number of Internet subscribers; more subscribers drove businesses to increase their presence on the Internet; more business presence increased subscribers' demands for increased functionality on the Internet. The demand to provide useful applications not only drives the further-increased access speeds, but continues to drive the further increase in the number of subscribers, the level of business presence, and the availability of useful applications in the global electronic market (e-market). Application servers are the underlying infrastructure for supplying these useful applications to end users or business-to-business (B2B) transactions.

An application server is software on a computer within a distributed network that “serves” its business or application logic to another program. The application server is often viewed as part of a three-tiered application consisting of a graphical user interface (GUI) server, the application server, and a database or transaction server. The application server typically acts as the intelligent interface between the GUI front-end, which may comprise a web browser, and the back-end database or processing systems.

A service provider will typically have an idea for a desired service to provide to customers. The service provider codes the service idea into server logic and then deploys that logic into a desired application server platform. A wealth of different application server platforms are available. Each platform has its own configuration and compatibility requirements, such that server logic is typically specifically coded to operate on a particular vendor's application server. Therefore, once the service provider selects the particular application server platform to use, its past, existing, and future server logic is generally dependent on the survival of, and continued support of, that particular application server platform.

Some application server platforms, such as HEWLETT-PACKARD COMPANY'S HP APPLICATION SERVER, BEA SYSTEMS INC.'s WEBLOGIC SERVER, and MACROMEDIA'S JRUN, INTERNATIONAL BUSINESS MACHINE'S (IBM) WEBSPHERE application servers, are fully-compliant with SUN MICROSYSTEM's JAVA 2 ENTERPRISE EDITION (J2EE) technology. However, even though these application servers are each J2EE compliant, there are configuration and compatibility differences among them. Other application server platforms, such as MICROSOFT'S MICROSOFT.NET application server, is based entirely on MICROSOFT'S proprietary NET technology. Therefore, service providers selecting the MICROSOFT.NET application server have typically committed to MICROSOFT'S future products for any planned additions.

If a service developer wishes to market specific server logic to a service provider, it would typically have to develop unique code for each application server platform used by the service provider. This duplicative process is extremely inefficient and raises the costs for service developers to develop broadly-applicable or marketable services. Similarly, if an application server platform is discontinued or no longer supported, service providers are faced with not only migrating to a new application server platform infrastructure, but also manually transcoding each of its server logic applications for compatibility with the new application server platform. Again, this transcoding process may be very expensive to the service provider.

### BRIEF SUMMARY OF THE INVENTION

Representative embodiments are directed to a software tool comprising conversion logic for automatically porting a web application from a first application server format to, a second application server format, and a user interface for receiving user input, wherein the conversion logic automatically executes according to the user input.

Additional representative embodiments are directed to a method for automatically converting a web application in a first format into at least one other format comprising prompting a user to select the at least one other format for transcoding the web application into, selecting ones of transformation templates from a database according to the user selection, and applying the selected ones of the transformation templates to the web application for automatically transcoding the web application into the at least one other format.

Further representative embodiments are directed to a computer program product having a computer-readable medium with computer program logic recorded thereon, the computer program product comprising code for cueing a user to select at least one application server format, code for choosing at least one conversion file from a plurality of conversion files responsive to the user selection, code for applying the at least one chosen conversion file to a web application, wherein the at least one chosen conversion file facilitates converting the web application from a first application server format to the at least one application server format, and code for generating information related to effects of conversion on the web application, wherein the information is made available to a user.

### BRIEF DESCRIPTION OF THE DRAWINGS

FIG. 1 is a high-level block diagram illustrating the logical positioning of one embodiment of a porting tool configured according to the teachings of the present invention;

FIG. 2 is a high-level block diagram illustrating the logical positioning of another embodiment of a porting tool configured according to the teachings of the present invention showing possible translation into multiple, different application server formats;

FIG. 3A is a code diagram illustrating an example Extensible Mark-Up Language (XML) document;

FIG. 3B is a code diagram illustrating an example Extensible Style-sheet Language for Transformations (XSLT) document;

FIG. 3C is a code diagram illustrating an example XML document resulting from the application of the XSLT document of FIG. 3B to the XML document of FIG. 3A; and

FIG. 4 is a detailed block diagram illustrating the porting tool of FIG. 1.

### DETAILED DESCRIPTION

FIG. 1 is a high-level block diagram illustrating the logical positioning of one embodiment of a porting tool configured according to the teachings of the present invention. Porting tool 100 is typically hosted on a computer system, such as computer 10. In operation, a service developer desiring to convert an application will generally use Application Server A (AS-A)-Application 101, configured for operation on AS-A 102, as a source file for porting tool 100. The output of porting tool 100 is preferably Application Server B (AS-B)-Application 103, which is now configured for operation on AS-B 104. Thus, the service developer is able to essentially automatically convert, translate, or transcode AS-A-Application 101 for use on AS-B 104.

It should be noted that embodiments implemented according to the teachings of the present invention may be embodied as software functionality on computer systems, such as computer 10. In such embodiments, software may preferably comprise code for cueing a user to select at least one application server format, code for choosing at least one conversion file from a plurality of conversion files responsive to the user selection, code for applying said at least one conversion file to a web application, and code for generating information related to effects of conversion on the web application and making that information available to a user. At least one conversion file would preferably facilitate converting the web application from a first application server format to the selected at least one application server format.

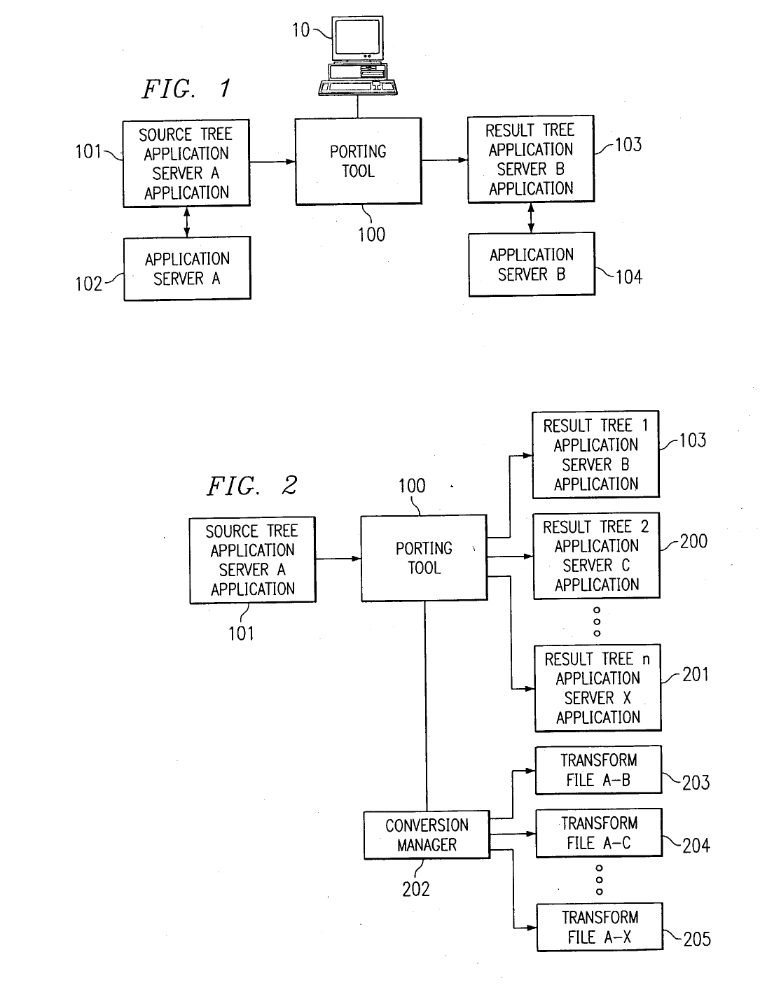

FIG. 2 is a high-level block diagram illustrating the logical positioning of another embodiment of a porting tool configured according to the teachings of the present invention showing possible translation into multiple, different application server formats. The service provider preferably inputs AS-A-Application 101 into porting tool 100 and then preferably selects one or more application server platforms into which AS-A-Application 101 is to be converted. In addition to transcoding AS-A-Application 101 into AS-B-Application 103, the service developer may preferably select to translate into AS-C-Application 200, AS-X-Application 201, or any combination of one or all of the available application server platforms. Once porting tool 100 has output any of the new application formats, they may preferably be deployed into the targeted application server platform.

In selected additional representative embodiments, conversion manager 202 monitors the conversion and transformation of each application server application and generates transform files, transform file A-B 203, transform file A-C 204, transform file A-X 205, and the like. Each of transform files 203-205 contain information on the effects of the transformation. Users may access transform files 203-205 through the user interface on computer 10.

Each application server platform maintains a configuration file for use by developers or code generating logic to configure documents and/or applications to that particular application server platform. These configuration files are typically written in extensible markup language (XML), as that language continues to grow in its universal applicability. Embodiments of the translation tool of the present invention leverage these XML configuration files to build a configuration repository for each application server platform that is desired for support. Once the configuration files of each of the supported application server platforms are gathered, extensible style sheet language (XSL) is used to form XSL for transformation (XSLT) documents that may preferably be used to help translate applications from one application server platform to another.

XSL is an XML-based language used to create style sheets. Style sheets are generally master page layout documents that define the layout or “look” of documents. XSLT is a subset language of XSL defined for building transformation documents. XSLT is used to convert an XML document into another XML document, a hypertext markup language (HTML) document, a portable document format (PDF), or the like.

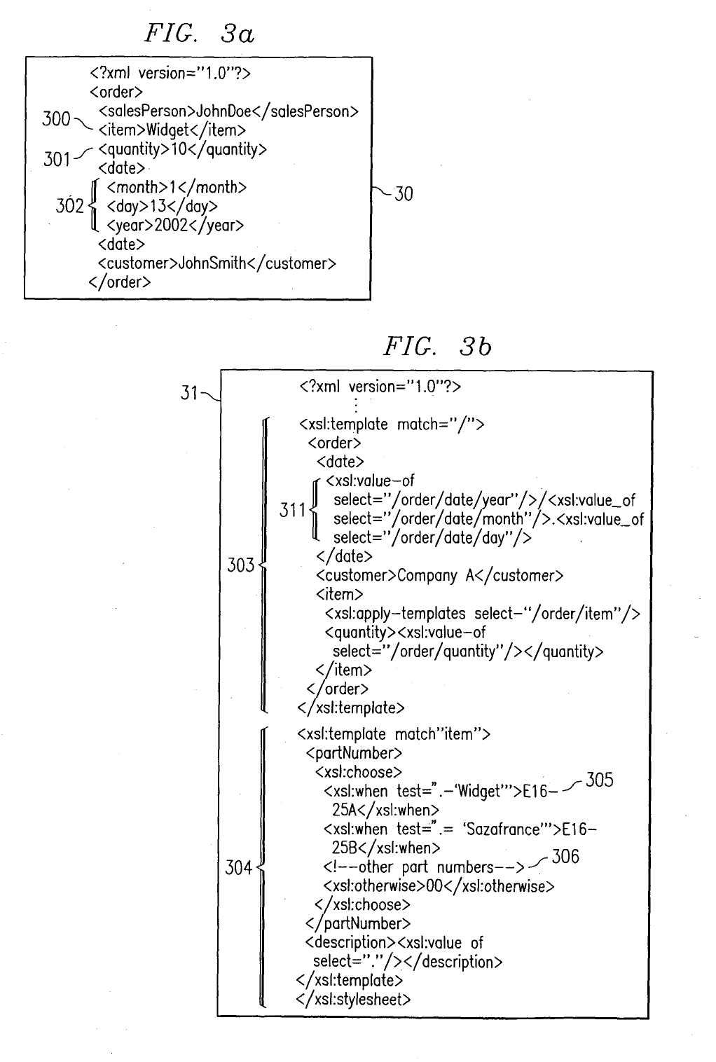

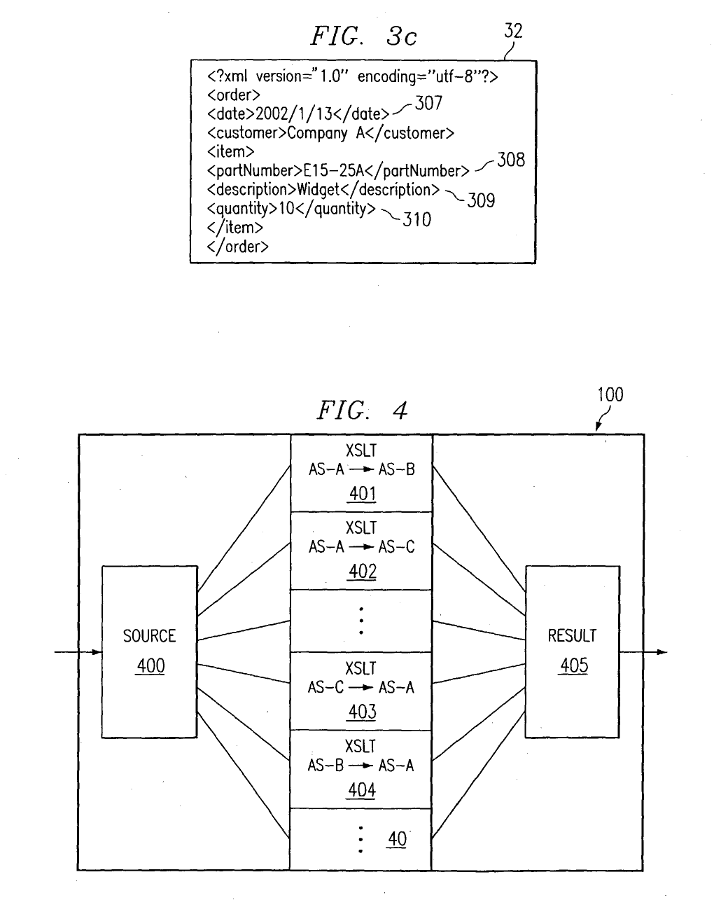

FIG. 3A is a code diagram illustrating an example XML document. XML document 30 describes an order form document for Company A. FIG. 3B is a code diagram illustrating an example XSLT document. FIG. 3C is a code diagram illustrating an example XML document resulting from the application of the XSLT document of FIG. 3B to the XML document of FIG. 3A. Among other things, Company A's order form requires item name 300, quantity 301, and date 302. Customer A orders its products from Manufacturer A. Manufacturer A's order form, shown in XML document 32 (FIG. 3C) requires date 307 (in yyyy/mm/dd format), part number 308, item description 309, and quantity 310. In order to convert XML document 30 (FIG. 3A) into XML document 32 (FIG. 3C), XSLT document 31 (FIG. 3C) is used.

XSLT document 31 (FIG. 3B) includes order conversion section 303 and part number conversion section 304. In order conversion section 303, XSL script 311 selects the information from date 302 (FIG. 3A) and converts it into the appropriate format for date 307 (FIG. 3B). Similarly, part number conversion section 304 (FIG. 3B) includes a conversion chart that selects the information on item name 300 (FIG. 3A) and converts in line 305 (FIG. 3B) to the correct part number for part number 308 (FIG. 3C). Therefore, after running XML document 30 (FIG. 3A) through with XSLT document 31 (FIG. 3B), XML document 32 (FIG. 3C) will be produced having the appropriate format of date 307, part number 308, description 309, and quantity 310.

FIG. 4 is a detailed block diagram illustrating the porting tool of FIG. 1. Porting tool 100 is created by loading transformation repository 40 with XSLT files written for converting one application server configuration file to another application server configuration file. As an application enters porting tool 100 it is used as source 400 for selected ones of XSLT documents 401-404 to transform into result 405. Any ones of XSLT documents 401-404 may preferably be selected for automatically transforming the application as desired by the user or developer.

Porting tool 100 is preferably created by examining the XML configuration files of each application server that the tool provider desires to support. Once the programmer identifies each XML configuration file, the XSLT file may preferably be coded to create each of the specific XSLT conversion documents.

It should be noted that the porting tool may be updated by adding new XSLT files to the XSLT database/repository. These updates enable the tool user to port applications to additional application server platforms.

What is claimed is:

1. A software tool comprising:
conversion logic for automatically porting a web application from a first application server format to a second application server format; and
a user interface for receiving user input, wherein said conversion logic automatically executes according to said user input.

2. The software tool of claim 1 wherein said conversion logic comprises:
a transformation repository storing a plurality of transformation files; and
a logic engine for applying ones of said transformation files selected by said user input to said web application, wherein said logic engine outputs said web application ported into said second application server format.

3. The software tool of claim 2 wherein said conversion logic further comprises:
a conversion manager for generating an information file of effects of said porting on said web application, wherein said information file is available on said user interface.

4. The software tool of claim 2 wherein each of said plurality of transformation files contains instructions for porting said first application server format into said second application server format.

5. The software tool of claim 2 wherein said plurality of transformation files are coded by a developer of said software tool, and wherein said developer stores said coded transformation files into said transformation repository.

6. The software tool of claim 1 wherein a plurality of transformation files are extensible style sheet language transformation (XSLT) documents.

7. The software tool of claim 1 wherein a plurality of transformation files are created by a developer of said software tool using configuration files for said first application server format and said second application server format.

8. The software tool of claim 7 wherein said configuration files are extensible markup language (XML) documents.

9. A method for automatically converting a web application in a first format into at least one other format comprising:
prompting a user to select said at least one other format for transcoding said web application into;
selecting ones of transformation templates from a database according to said user selection; and
applying said selected ones of said transformation templates to said web application for automatically transcoding said web application into said at least one other format.

10. The method of claim 9 wherein said assembling step further comprises:
assembling a database of transformation templates.

11. The method of claim 9 wherein said assembling step further comprises:
obtaining configuration files for a plurality of formats; and
coding each of said transformation templates for each one of said plurality of formats, wherein each of said transformation templates comprises code for transcoding from one of said formats to another of said formats.

12. The method of claim 9 further comprising:
generating information related to effects of said transcoding on said web application, wherein said information is made available to said user.

13. The method of claim 9 further comprising:
transforming said web application using extensible style sheet language transformation (XSLT) documents.

14. The method of claim 11 further comprising:
obtaining said configuration files comprising extensible markup language (XML) documents.

15. A computer program product having a computer-readable medium with computer program logic recorded thereon, said computer program product comprising:
code for cueing a user to select at least one application server format;
code for choosing at least one conversion file from a plurality of conversion files responsive to said user selection;
code for applying said at least one chosen conversion file to a web application, wherein said at least one chosen conversion file facilitates converting said web application from a first application server format to said at least one application server format; and
code for generating information related to effects of conversion on said web application, wherein said information is made available to a user.

16. The computer program product of claim 15 wherein said at least one conversion file comprises an extensible style sheet language transformation (XSLT) file.
